(19) United States
(12) Patent Application Publication
(10) Pub. No.: US 2026/0152626 A1
(43) Pub. Date: Jun. 4, 2026

(54) GLASS FIBER REINFORCED POLYAMIDE MATERIALS AND METHODS FOR PREPARING THEREOF

(71) Applicant: JIANGSU BOILN PLASTICS CO., LTD., Suzhou (CN)

(72) Inventors: Yong ZHU, Suzhou (CN); Yong LIU, Suzhou (CN); Shen ZHANG, Suzhou (CN)

(73) Assignee: JIANGSU BOILN PLASTICS CO., LTD., Suzhou (CN)

(21) Appl. No.: 18/964,291

(22) Filed: Nov. 29, 2024

(51) Int. Cl. C08K 13/04; C08J 3/20; C08K 3/30; C08K 5/01; C08K 5/20; C08K 5/23; C08K 5/3492; C08K 7/14

(52) U.S. Cl. CPC C08K 13/04; C08J 3/203; C08J 2377/02; C08K 2003/3036; C08K 5/01; C08K 5/20; C08K 5/23; C08K 5/3492; C08K 7/14; C08K 2201/014; C08K 2201/016

(57) ABSTRACT

Embodiments of the present disclosure provide a glass fiber reinforced polyamide material and a method for preparing thereof. The glass fiber reinforced polyamide material includes components in the following parts by weight: 48-99.8 parts of a polyamide resin, 0-50 parts of a glass fiber, 0.05-2 parts of a thermal stability additive, and 0.1-2 parts of other additives. The thermal stability additive is hydroxyphenyltriazine compounds.

### TECHNICAL FIELD

The present disclosure relates to the technical field of polymer materials, and in particular, relates to glass fiber reinforced polyamide materials and methods for preparing thereof.

### BACKGROUND

Polyamide is an engineering plastic with significant advantages such as a tough texture, good physical and mechanical properties, a low coefficient of friction, and resistance to wear. These characteristics make it suitable for manufacturing a variety of transmission components. However, if an amorphous polyamide is exposed to a high temperature above its glass transition temperature, or if a semi-crystalline polyamide is exposed to a relatively high temperature in the range of a melting temperature, the polyamide may undergo discoloration due to thermal degradation. Furthermore, small molecules generated by the thermal degradation of the polyamide can react with a toner, resulting in discoloration or fading of the toner, which results in a distortion of the color of the polyamide and affect the quality of the product.

In order to ameliorate the problem of discoloration of the polyamide, the person skilled in the art prevents discoloration of the polyamide by adding an antioxidant to the polyamide. A commonly used antioxidant is a complex of a phenolic antioxidant and a phosphite antioxidant, but this type of antioxidant is unable to solve the problem of discoloration of polyamide at a high processing temperature.

Therefore, there is a need to provide a glass fiber reinforced polyamide material and a method for preparing thereof to improve the stability of the polyamide material under a high temperature, so as to maintain the color stability of the polyamide material.

### SUMMARY

Embodiments of the present disclosure provide a glass fiber reinforced polyamide material, the glass fiber reinforced polyamide material including components in the following parts by weight: 48-99.8 parts of a polyamide resin, 0-50 parts of a glass fiber, 0.05-2 parts of a thermal stability additive, and 0.1-2 parts of other additives. The thermal stability additive is hydroxyphenyltriazine compounds.

In some embodiments, the thermal stability additive is 0.05-0.5 parts.

In some embodiments, the hydroxyphenyltriazine compounds include at least one of 2,4-bis(2,4-dimethylphenyl)-6-(2-hydroxy-4-octyloxyphenyl)-s-triazine, 2-(4,6-diphenyl-1,3,5-triazin-2-yl)-5-hexyloxy, or 2-[4,6-di(4-biphenylyl)-1,3,5-triazine-2-yl]-5-(2-ethylhexyloxy) phenol.

In some embodiments, the polyamide resin includes at least one of PA6, PA66, PA46, PA56, PA66/6, PA6T, PA9T, PA610, PA611, or PA612.

In some embodiments, the other additives include at least one of a toner, a lubricant, or an antioxidant.

In some embodiments, the toner includes at least one of zinc sulfide, or an organic pigment.

In some embodiments, the organic pigment includes at least one of an azo pigment, a heterocyclic pigment, a perylene pigment, or a metal complex pigment.

In some embodiments, the lubricant includes at least one of stearate, N,N-ethylene bis stearic acid amide, pentaerythritol stearate, silicone powder, or polyethylene wax.

In some embodiments, the antioxidant includes at least one of an antioxidant S2225P, an antioxidant 168, an antioxidant 1010, or an antioxidant 1098.

In some embodiments, a length-to-diameter ratio of the glass fiber is (20-40):1.

In some embodiments, a color change chromatic aberration ΔE of the glass fiber reinforced polyamide material at a temperature of 250-280° C. is 0.15-0.92.

Embodiments of the present disclosure provide a method for preparing the glass fiber reinforced polyamide material. The method includes: mixing 48-99.8 parts by weight of the polyamide resin, 0-50 parts by weight of the glass fiber, 0.05-2 parts by weight of the thermal stability additive, and 0.1-2 parts by weight of other additives uniformly by a mixer to obtain a mixture, the thermal stability additive being hydroxyphenyltriazine compounds; adding the mixture to a twin-screw extruder for melt blending and extruding strands, an extrusion temperature of the strands being 240-280° C.; and pelletizing the strands by a pelletizer, drying by an elevator, and packaging to obtain the glass fiber reinforced polyamide material.

In some embodiments, the thermal stability additive is 0.05-0.5 parts.

### BRIEF DESCRIPTION OF THE DRAWINGS

The present disclosure will be further illustrated by way of exemplary embodiments, which will be described in detail by means of the drawings. These embodiments are not limiting, and in these embodiments, the same numbering denotes the same structure.

FIG. 1 is an exemplary flowchart illustrating a method for preparing a glass fiber reinforced polyamide material according to some embodiments of the present disclosure.

### DETAILED DESCRIPTION

In order to make the technical problem to be solved, the technical solution and the beneficial effect of the present disclosure clearer and more understandable, the technical solution of the present disclosure will be described below in conjunction with embodiments. It should be understood that the specific embodiments described herein are only for explaining the present disclosure, and are not intended to limit the present disclosure. Obviously, the drawings in the following description are only some examples or embodiments of the present disclosure, and that the present disclosure can be applied to other similar scenarios according to these drawings without creative labor for those of ordinary skilled in the art. Unless obviously obtained from the context or the context illustrates otherwise, the same numeral in the drawings refers to the same structure or operation.

As shown in the present disclosure and in the claims, unless the context clearly suggests an exception, the words “one”, “a”, and/or “the” do not refer specifically to the singular, but may also include the plural. In general, the terms “including” and “comprising” only suggest the inclusion of explicitly identified steps and elements that do not constitute an exclusive list, and the method or apparatus may also include other steps or elements.

Under high temperature condition, a polyamide is subject to discoloration due to thermal degradation, and small molecules generated by the thermal degradation of the polyamide will further react with a toner, resulting in discoloration or fading of the toner, which will result in a distortion of the color of the polyamide and affect the quality of the product. Embodiments of the present disclosure may reduce the color change of the polyamide during high temperature by adding hydroxyphenyltriazine compounds to a glass fiber reinforced polyamide material.

Embodiments of the present disclosure provide a glass fiber reinforced polyamide material. The glass fiber reinforced polyamide material includes components in the following parts by weight: 48-99.8 parts of a polyamide resin, 0-50 parts of a glass fiber, 0.05-2 parts of a thermal stability additive, and 0.1-2 parts of other additives. The thermal stability additive is hydroxyphenyltriazine compounds.

A plurality of intramolecular hydrogen bonds are formed between a hydroxyl hydrogen on the benzene ring and a neighboring nitrogen atom of the hydroxyphenyltriazine compounds, and the plurality of intramolecular hydrogen bonds form a chelate ring. At a high temperature, molecules thermally vibrate, the hydrogen bonds rupture, the chelating ring opens, and the hydroxyphenyltriazine compounds form ionic compounds, which have an ability to capture free radicals, inhibit or retard the polyamide degradation, and improve the thermal stability of the polyamide.

In some embodiments, the hydroxyphenyltriazine compounds in the glass fiber reinforced polyamide material is 0.05-0.5 parts. In some embodiments, the hydroxyphenyltriazine compounds in the glass fiber reinforced polyamide material can be 0.05 parts, 0.1 parts, 0.2 parts, 0.3 parts, 0.5 parts, or the like. In some embodiments, the hydroxyphenyltriazine compounds are effective in controlling their precipitation on the surface of the polyamide material.

In some embodiments, the hydroxyphenyltriazine compounds include at least one of 2,4-bis(2,4-dimethylphenyl)-6-(2-hydroxy-4-octyloxyphenyl)-s-triazine (UV-1164), 2-[4,6-bis(2,4-dimethylphenyl)-1,3,5-triazin-2-yl]-5-(octyloxy) phenol (Chiguard® 1064), 2-(4,6-diphenyl-1,3,5-triazin-2-yl)-5-hexyloxy (Tinuvin® 1577), or 2-[4,6-di(4-biphenylyl)-1,3,5-triazine-2-yl]-5-(2-ethylhexyloxy) phenol (Tinuvin® 1600).

In some embodiments, the polyamide resin includes at least one of PA6, PA66, PA46, PA56, PA66/6, PA6T, PA9T, PA610, PA611, or PA612. In some embodiments, the polyamide resin is PA6.

The glass fiber may increase the overall strength of the polyamide resin. The length-to-diameter ratio of the glass fiber may affect the load-bearing capacity and compression resistance of the glass fiber reinforced polyamide material after molding. In some embodiments, the length-to-diameter ratio of the glass fiber is (20-40):1. In some embodiments, the length-to-diameter ratio of the glass fiber is 20:1, 30:1, 40:1, or the like.

The other additives are adjuvants that can improve the quality of the glass fiber reinforced polyamide material. In some embodiments, the other additives include at least one of a toner, a lubricant, or an antioxidant.

The toner can be used for coloring the polyamide resin. In some embodiments, the toner includes at least one of zinc sulfide, or an organic pigment. In some embodiments, the organic pigment includes at least one of an azo pigment, a heterocyclic pigment, a preylene pigment, or a metal complex pigment. In some embodiments, the azo pigment includes a monoazo pigment, a diazo pigment, or the like. For example, the addition of zinc sulfide gives the final product of the glass fiber reinforced polyamide material a white color, while the addition of the monoazo pigment gives the final product a yellow color.

During processing, the polyamide may have problems such as roughness of the product, lack of luster, and exposed glass fibers due to a high viscosity of its melt. Adding a lubricant to the glass fiber reinforced polyamide material can, on the one hand, improve the bonding state of the glass fiber with the polyamide resin, and thus improve the dispersion of the glass fiber in the polyamide resin; on the other hand, it can also improve the processing fluidity and the surface finish of the glass fiber reinforced polyamide material. In some embodiments, the lubricant includes at least one of stearate, N,N-ethylene bis stearic acid amide, pentaerythritol stearate, silicone powder, or polyethylene wax. The person skilled in the art may select an appropriate lubricant according to actual needs, and no specific limitation is made herein.

The antioxidant can reduce a rate of a thermal oxidation reaction of plastic macromolecules, slow down the thermal and oxygen degradation of the plastic resin, and extend the life span of a plastic product. In some embodiments of the present disclosure, a heat resistance of the glass fiber reinforced polyamide material are improved by adding the antioxidant. In some embodiments, the antioxidant includes at least one of an antioxidant S2225P, an antioxidant 168, an antioxidant 1010, or an antioxidant 1098. The person skilled in the art may select an appropriate antioxidant according to actual needs, and no specific limitation is made herein.

A color change chromatic aberration ΔE is a quantitative representation of the difference in color perception between two colors based on the CIELAB color difference theory. In some embodiments, the color change chromatic aberration ΔE of the glass fiber reinforced polyamide material at a temperature of 250-280° C. is 0.15-0.92. In some embodiments, the color change chromatic aberration ΔE of the glass fiber reinforced polyamide material at a temperature of 260° C. is 0.16. In some embodiments, the color change chromatic aberration ΔE of the glass fiber reinforced polyamide material at a temperature of 280° C. is 0.90.

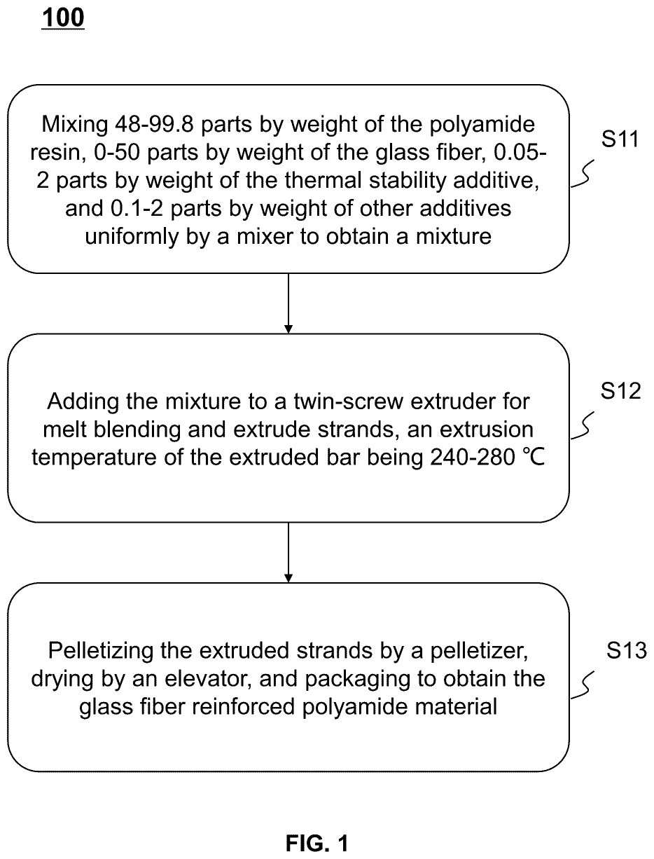

Embodiments of the present disclosure also provide a method for preparing the glass fiber reinforced polyamide material. FIG. 1 is an exemplary flowchart illustrating a method for preparing a glass fiber reinforced polyamide material according to some embodiments of the present disclosure. As shown in FIG. 1, the process 100 includes the following steps.

S11, 48-99.8 parts by weight of the polyamide resin, 0-50 parts by weight of the glass fiber, 0.05-2 parts by weight of the thermal stability additive, and 0.1-2 parts by weight of other additives are mixed uniformly by a mixer to obtain a mixture. The thermal stability additive is hydroxyphenyltriazine compounds.

In some embodiments, the thermal stability additive is 0.05-0.5 parts. In some embodiments, the thermal stability additive in the glass fiber reinforced polyamide material is 0.05 parts, 0.1 parts, 0.2 parts, 0.3 parts, 0.5 parts, or the like.

S12: the mixture obtained in step S11 is added to a twin-screw extruder for melt blending and strands are extruded. An extrusion temperature of the strands is 240-280° C.

In some embodiments, a screw speed of the twin-screw extruder is 300-500 rpm. In some embodiments, the screw speed of the twin-screw extruder is 300 rpm, 350 rpm, 400 rpm, 450 rpm, or 500 rpm, etc.

S13: the strands obtained in step S12 are pelletized by a pelletizer, dried by an elevator, and packaged to obtain the glass fiber reinforced polyamide material.

It should be noted that the foregoing description of the process 100 is intended to be exemplary and illustrative only and does not limit the scope of application of the present disclosure. For a person skilled in the art, various corrections and changes can be made to the process 100 under the guidance of the present disclosure. However, these corrections and changes remain within the scope of the present disclosure.

Beneficial effects that may be achieved by embodiments of the present disclosure include, but are not limited to the following advantages.

The glass fiber reinforced polyamide material provided by embodiments of the present disclosure can reduce the color change of the polyamide at a high temperature by the addition of hydroxyphenyltriazine compounds. At a high temperature, molecules thermally vibrate, and the hydroxyphenyltriazine compounds form ionic compounds, which have an ability to capture free radicals, and thus can inhibit or delay the polyamide degradation and improve the thermal stability of the polyamide. The thermal stability of the polyamide is improved so that, on the one hand, the problem of discoloration of the polyamide due to thermal degradation can be avoided, and on the other hand, a further reaction between small molecules produced by the thermal degradation of the polyamide and the toner can be prevented, thereby solving the problem of discoloration of the polyamide.

The present disclosure is described in detail below in connection with specific embodiments. The following embodiments will be helpful to those skilled in the art to further understand the present invention, but do not limit the invention in any way. It should be noted that to a person of ordinary skilled in the art, a number of adjustments and improvements can be made without departing from the conception of the present invention. These all fall within the scope of protection of the present invention.

The experimental methods used in the following embodiments are conventional, if not otherwise stated. The experimental materials used in the following embodiments are, if not otherwise specified, obtained by purchase from a conventional biochemical reagent company. It should be understood that the following embodiments are intended to better explain the present invention and are not intended to limit the invention.

### EXAMPLES

The raw materials used in Examples and Comparative Examples are described as follows:
PA6 resin: produced by KuibyshevAzot, a viscosity of 2.5;
Glass Fiber: produced by Taishan Fiberglass Inc., Taishan Staple Fiber EC10-3.0-T435TM;
2-(4,6-diphenyl-1,3,5-triazin-2-yl)-5-hexyloxy (Tinuvin® 1577): produced by Shanghai Puzhan Industrial Co., Ltd., UV1577;
2-[4,6-di(4-biphenylyl)-1,3,5-triazine-2-yl]-5-(2-ethylhexyloxy) phenol (Tinuvin® 1600): produced by BASF, UV1600;
Zinc Sulfide: produced by Sachtleben Chemie GmbH, Zinc Sulfide HD-S;
Monoazo pigment: produced by LANXESS, bayplast yellow G;
Perylene pigment: produced by BASF, K3911;
Lubricant N,N-Ethylene bis stearic acid amide: produced by Lonza USA, Acrawax C; and
Antioxidant S2225P: produced by Arbor, USA, S2225P.

### Comparative Example 1

A glass fiber reinforced polyamide material includes components in the following parts by weight:
69.2 parts of PA6 resin, 30 parts of a glass fiber, 0.3 parts of a lubricant N,N-ethylene bis stearic acid amide, and 0.5 parts of an antioxidant S2225P.

The method for preparing the glass fiber reinforced polyamide material of Comparative Example 1 includes:
(1) mixing 69.2 parts by weight of the PA6 resin, 30 parts by weight of the glass fiber, 0.3 parts by weight of the lubricant N, N-ethylene bis stearic acid amide, and 0.5 parts by weight of the antioxidant S2225P uniformly by a mixer to obtain a mixture;
(2) adding the mixture obtained in step (1) to a twin-screw extruder for melt blending, and extruding strands. An extrusion temperature of the strands is 245° C.;
(3) pelletizing the strands obtained in step (2) by a pelletizer, drying by an elevator, and packaging to obtain the glass fiber reinforced polyamide material; and
(4) testing performance of the material:

Thermo-oxidative yellowing resistance: the glass fiber reinforced polyamide material is injection molded into a color plate at 250° C., 265° C. and 280° C., respectively. A color measurement is performed by a spectrophotometer with a light source of D65, a chromatic aberration is characterized by CIELab method, and a color quality of the color plate is tested by determining a CIELab value.

The color change chromatic aberration ΔE of the color plate is calculated by the following equation (1):

$$Δ E = {[ {( Δ {L}^{⋆} )}^{2} + {( Δ {a}^{⋆} )}^{2} + {( Δ {b}^{⋆} )}^{2} ]}^{1 / 2} \qquad ( 1 )$$

where L* indicates a color luminance of the color plate, 0≤L*≤100. L*=0 indicates that the color plate is black, and L*=100 indicates that the color plate is white, and ΔL* indicates a change value of the color luminance of the color plate a* and b* indicate positions of the color of the color plate on the red/green axis and yellow/blue axis, respectively. The greater an absolute value of a* or b*, the higher the saturation of the color plate, −128≤a*≤127, −128≤b*≤127. Δa* indicates a change value of a*, Δb* indicates a change value of b*.

### Comparative Example 2

A glass fiber reinforced polyamide material includes components in the following parts by weight:
68.5 parts of PA6 resin, 30 parts of a glass fiber, 0.3 parts of a lubricant N,N-ethylene bis stearic acid amide, 0.5 parts of an antioxidant S2225P, 0.5 parts of zinc sulfide, and 0.2 parts of a monoazo pigment.

A method for preparing a glass fiber reinforced polyamide material of Comparative Example 2 includes:
(1) mixing 68.5 parts by weight of PA6 resin, 30 parts by weight of the glass fiber, 0.3 parts by weight of the lubricant N, N-ethylene bis stearic acid amide, 0.5 parts by weight of the antioxidant S2225P, 0.5 parts by weight of the zinc sulfide, and 0.2 parts by weight of the monoazo pigment uniformly by a mixer to obtain a mixture;
(2) adding the mixture obtained in step (1) to a twin-screw extruder for melt blending and extruding strands. The extrusion temperature of the strands is 245° C.; and
(3) pelletizing the strands obtained in step (3) by a pelletizer, drying by an elevator, and packaging to obtain the glass fiber reinforced polyamide material. The glass fiber reinforced polyamide material is tested for material performance according to step (4) in Comparative Example 1.

### Example 1

A glass fiber reinforced polyamide material includes components in the following parts by weight:
69.1 parts of PA6 resin, 30 parts of a glass fiber, 0.3 parts of a lubricant N,N-ethylene bis stearic acid amide, 0.5 parts of an antioxidant S2225P, and 0.1 parts of Tinuvin® 1577.

A method for preparing the glass fiber reinforced polyamide material of Example 1 includes:
(1) mixing 69.1 parts by weight of PA6 resin, 30 parts by weight of a glass fiber, 0.3 parts by weight of a lubricant N,N-ethylene bis stearic acid amide, 0.5 parts by weight of an antioxidant S2225P, and 0.1 parts by weight of Tinuvin® 1577 uniformly by a mixer to obtain a mixture;
(2) adding the mixture obtained in step (1) to a twin-screw extruder for melt blending and extruding a strands. An extrusion temperature of the strands is 245° C.; and
(3) pelletizing the strands obtained in step (2) by a pelletizer, drying by an elevator, and packaging to obtain the glass fiber reinforced polyamide material. The glass fiber reinforced polyamide material is tested for material performance according to step (4) in Comparative Example 1.

### Example 2

Example 2 differs from Example 1 by replacing 0.1 parts of Tinuvin® 1577 with 0.3 parts of Tinuvin® 1577.

### Example 3

Example 3 differs from Example 1 by replacing 0.1 part of Tinuvin® 1577 with 0.1 parts of Tinuvin® 1600.

### Example 4

Example 4 differs from Example 1 by replacing 0.1 parts of Tinuvin® 1577 with 0.3 parts of Tinuvin®1600.

### Example 5

A glass fiber reinforced polyamide material includes components in the following parts by weight:
68.4 parts of PA6 resin, 30 parts of a glass fiber, 0.3 parts of a lubricant N,N-ethylene bis stearic acid amide, 0.5 parts of an antioxidant S2225P, 0.5 parts of zinc sulfide, 0.2 parts of a monoazo pigment, 0.1 parts of Tinuvin® 1577.

A method for preparing the glass fiber reinforced polyamide material of Example 5 includes:
(1) mixing 68.4 parts by weight of PA6 resin, 30 parts by weight of the glass fiber, 0.3 parts by weight of the lubricant N, N-ethylene bis stearic acid amide, 0.5 parts by weight of the antioxidant S2225P, 0.5 parts by weight of the zinc sulfide, 0.2 parts by weight of the monoazo pigment, and 0.1 parts by weight of Tinuvin® 1577 uniformly by a mixer to obtain a mixture;
(2) adding the mixture obtained in step (1) to a twin-screw extruder for melt blending and extruding strands. An extrusion temperature of the strands is 245° C.; and
(3) pelletizing the strands obtained in step (2) by a pelletizer, drying by an elevator, and packaging to obtain the glass fiber reinforced polyamide material. The glass fiber reinforced polyamide material is tested for material performance according to step (4) in Comparative Example 1.

### Example 6

Example 6 differs from Example 5 by replacing 0.1 parts of Tinuvin® 1577 with 0.3 parts of Tinuvin® 1577.

### Example 7

Example 7 differs from Example 5 by replacing 0.1 parts of Tinuvin® 1577 with 0.1 parts of Tinuvinc 1600.

### Example 8

Example 8 differs from Example 5 by replacing 0.1 parts Tinuvin® 1577 with 0.3 parts of Tinuvin® 1600.

### Example 9

A glass fiber reinforced polyamide material includes components in the following parts by weight:
66.5 parts of PA6 resin, 30 parts of a glass fiber, 0.3 parts of a lubricant N,N-ethylene bis stearic acid amide, 0.5 parts of an antioxidant S2225P, 0.5 parts of zinc sulfide, 0.2 parts of Thiazol Yellow G, and 2 parts of Tinuvin® 1600.

A method for preparing the glass fiber reinforced polyamide material of Example 5 includes:
(1) mixing 66.5 parts by weight of PA6 resin, 30 parts by weight of the glass fiber, 0.3 parts by weight of the lubricant N,N-ethylene bis stearic acid amide, 0.5 parts by weight of the antioxidant S2225P, 0.5 parts by weight of the zinc sulfide, 0.2 parts by weight of Thiazol Yellow G, and 2 parts by weight of Tinuvin® 1600 uniformly by a mixer to obtain a mixture;
(2) adding the mixture obtained in step (1) to a twin-screw extruder for melt blending and extruding strands. An extrusion temperature of the strands is 245° C.; and
(3) pelletizing the strands obtained in step (2) by a pelletizer, drying by an elevator, and packaging to obtain the glass fiber reinforced polyamide material. The glass fiber reinforced polyamide material is tested for material performance according to step (4) in Comparative Example 1. Testing results of Examples 1-9 and Comparative Examples 1-2 are shown in Table 1.

TABLE 1
Testing results of performances of glass fiber reinforced polyamide materials prepared in Examples 1-9 and Comparative Examples 1-2

| | | Compar- | Compar- | | | | | | | | | |
|---|---|---|---|---|---|---|---|---|---|---|---|---|
| | color | ative | ative | | | | | | | | | |
| Temper- | con- | Example | Example | Example | Example | Example | Example | Example | Example | Example | Example | Example |
| ature | trast | 1 | 2 | 1 | 2 | 3 | 4 | 5 | 6 | 7 | 8 | 9 |
| 250° C. | L* | 78.51 | 81.40 | 78.91 | 79.95 | 79.27 | 80.95 | 81.04 | 80.81 | 81.30 | 81.28 | 81.32 |
| | a* | −5.58 | 4.34 | −6.51 | −7.40 | −7.41 | −8.45 | 5.29 | 5.96 | 4.74 | 4.96 | 5.01 |
| | b* | 12.60 | 80.85 | 13.01 | 12.04 | 13.88 | 13.66 | 81.45 | 81.80 | 81.21 | 81.29 | 81.32 |
| 265° C. | L* | 78.50 | 81.35 | 78.90 | 79.93 | 79.24 | 80.91 | 81.03 | 80.78 | 81.24 | 81.25 | 81.3 |
| | a* | −5.64 | 4.25 | −6.53 | −7.52 | −7.51 | −8.54 | 5.21 | 5.90 | 4.66 | 4.91 | 4.98 |
| | b* | 11.92 | 80.48 | 12.41 | 11.73 | 13.56 | 13.56 | 81.12 | 81.43 | 81.04 | 81.15 | 81.3 |
| 280° C. | L* | 78.08 | 81.35 | 78.72 | 79.80 | 79.11 | 80.85 | 81.02 | 80.78 | 81.25 | 81.21 | 81.22 |
| | a* | −5.64 | 3.77 | −6.62 | −7.53 | −7.59 | −8.66 | 4.76 | 5.77 | 4.56 | 4.79 | 4.91 |
| | b* | 11.25 | 80.02 | 11.82 | 11.33 | 13.25 | 13.44 | 80.70 | 81.21 | 80.74 | 81.05 | 81.22 |
| 265° C. | ΔL* | −0.01 | −0.05 | −0.01 | −0.02 | −0.03 | −0.04 | −0.01 | −0.03 | −0.06 | −0.02 | −0.02 |
| vs | Δa* | −0.06 | −0.09 | −0.02 | −0.12 | −0.10 | −0.10 | −0.08 | −0.06 | −0.08 | −0.05 | −0.03 |
| 250° C. | Δb* | −0.68 | −0.37 | −0.60 | −0.31 | −0.32 | −0.10 | −0.33 | −0.30 | −0.21 | −0.14 | −0.03 |
| | ΔE | 0.69 | 0.38 | 0.61 | 0.34 | 0.34 | 0.15 | 0.34 | 0.31 | 0.23 | 0.15 | 0.015 |
| 280° C. | ΔL* | −0.43 | −0.05 | −0.19 | −0.15 | 0.16 | −0.10 | −0.02 | −0.03 | −0.05 | −0.07 | −0.1 |
| vs | Δa* | −0.06 | −0.57 | −0.11 | −0.13 | −0.18 | −0.11 | −0.53 | −0.19 | −0.18 | −0.17 | −0.1 |
| 250° C. | Δb* | −1.35 | −0.84 | −1.19 | −0.71 | −0.63 | −0.22 | −0.75 | −0.59 | −0.47 | −0.23 | −0.1 |
| | ΔE | 1.42 | 1.01 | 1.21 | 0.73 | 0.68 | 0.27 | 0.92 | 0.62 | 0.51 | 0.29 | 0.17 |

From the testing results in Table 1 above:
1. According to the testing results of Comparative Example 1, as a temperature of the injection molding process increased from 250° C. to 280° C., the value of b* of the glass fiber reinforced polyamide material decreases more, indicating a more severe thermal degradation of the PA6 resin. According to the testing results of Examples 1-2, after the addition of Tinuvin® 1577, the decrease in the b* value of the glass fiber reinforced polyamide material is significantly reduced and ΔE became smaller. Within a certain range, with the increase of the mass of Tinuvin® 1577, the decrease of the b* value of the glass fiber reinforced polyamide material is further reduced and the ΔE becomes smaller, indicating that Tinuvin® 1577 can reduce the color change of PA6 resin caused by thermal degradation during a thermal processing.
2. Comparing the testing results of Comparative Example 1 and Examples 3-4, it can be seen that after the addition of Tinuvin® 1600 to the glass fiber reinforced polyamide material, with a temperature of the injection molding processing increased from 250° C. to 280° C., the decrease of b* value of the glass fiber reinforced polyamide material is significantly reduced and ΔE became smaller. In a certain range, with the increase of the mass of Tinuvin® 1600, the decrease of the b* value of the glass fiber reinforced polyamide material is further reduced and ΔE becomes smaller, indicating that Tinuvin® 1600 can reduce the color change of PA6 resin caused by thermal degradation during a thermal processing.
3. As can be seen from the testing results of Comparative Example 1 and Examples 1-4, compared with Tinuvin® 1577, adding the same mass of Tinuvin® 1600 to the glass fiber reinforced polyamide material, the b* value of the glass fiber reinforced polyamide material decreases less and ΔE is smaller, indicating that Tinuvin® 1600 provides a better protection against the color thermal stability of the glass fiber reinforced polyamide material.
4. As can be seen from the testing results of Comparative Example 2 and Examples 5-9, in the glass fiber reinforced polyamide material containing zinc sulfide and monoazo pigment, the b* value of the glass fiber reinforced polyamide material decreases more as the temperature of the injection molding processing increases from 250° C. to 280° C., indicating that the small molecules generated by thermal degradation of PA6 resin further react with the zinc sulfide and monoazo pigment, resulting in the discoloration of the zinc sulfide and monoazo pigment. The addition of Tinuvin® 1577 and Tinuvin® 1600 to the glass fiber reinforced polyamide material reduces the decrease of b* value and ΔE, which attenuates the degree of fading of the material. Tinuvin® 1600 is more effective in protecting the color thermal stability of the material.

### Comparative Example 3

A glass fiber reinforced polyamide material includes components in the following parts by weight:

69.2 parts of PA6 resin, 30 parts of a glass fiber, 0.3 parts of a lubricant N,N-ethylene bis stearic acid amide, 0.5 parts of an antioxidant S2225P, and 0.2 parts of a perylene pigment.

The method for preparing the glass fiber reinforced polyamide material of Comparative Example 3 includes:
(1) mixing 69.2 parts by weight of the PA6 resin, 30 parts by weight of the glass fiber, 0.3 parts by weight of the lubricant N,N-ethylene bis stearic acid amide, and 0.5 parts by weight of the antioxidant S2225P uniformly by a mixer to obtain a mixture;
(2) adding the mixture obtained in step (1) to a twin-screw extruder for melt blending and extruding strands. An extrusion temperature of the strands is 260° C. or 280° C.;
(3) pelletizing the strands obtained in step (2) by a pelletizer, drying by an elevator, and then transferring to an injection molding machine to be injected into a color plate to obtain a finished product. The injection molding parameters of the injection molding machine includes: a barrel temperature of 250° C. or 265° C. or 280° C., a first pressure of 1,000 bar, a second pressure of 900 bar, a speed of a first injection of 65 cm³/s, a speed of a second injection of 15 cm³/s; and
(4) Color plate test: after the color plate cooled in the dry state for 12 hours, a color test first performed using a spectrophotometer with a light source od D65. The chromatic aberration is characterized by the CIELab method, and color qualities of the color plates made in Comparative Example 3 and Example 10 are tested by determining CIELab values.

The color change chromatic aberration ΔE of the color plate is calculated by the following equation (2):

$$Δ E = {[ {( Δ L )}^{2} + {( Δ a )}^{2} + {( Δ b )}^{2} ]}^{1 / 2} \qquad ( 2 )$$

where L indicates a color luminance of the color plate, 0≤L≤100. L=0 indicates that the color plate is black, and L=100 indicates that the color plate is white. ΔL indicates a change value of the color luminance of the color plate. a and b indicate positions of the color of the color plate on the red/green axis and yellow/blue axis, respectively. The greater an absolute value of a or b, the higher the saturation of the color plate, −128≤a≤127, −128≤b≤127. Δa indicates a change value of a, and Δb indicates a change value of b.

### Example 10

A glass fiber reinforced polyamide material includes components in the following parts by weight:
69.1 parts of PA6 resin, 30 parts of a glass fiber, 0.3 parts of a lubricant N,N-ethylene bis stearic acid amide, 0.5 parts of an antioxidant S2225P, 0.2 parts of a perylene pigment, and 0.1 parts of Tinuvin® 1600.

The method for preparing the glass fiber reinforced polyamide material of Example 10 includes:
(1) mixing 69.1 parts by weight of PA6 resin, 30 parts by weight of the glass fiber, 0.3 parts by weight of the lubricant N,N-ethylene bis stearic acid amide, 0.5 parts by weight of the antioxidant S2225P, and 0.1 parts by weight of Tinuvin® 1600 uniformly by a mixer to obtain a mixture;
(2) adding the mixture obtained in step (1) to a twin-screw extruder for melt blending and extruding strands. An extrusion temperature of the strands is 260° C. or 280° C.; and
(3) pelletizing the strands obtained in step (2) by a pelletizer, drying by an elevator, and then transferring to an injection molding machine to be injected into a color plate to obtain a finished product. The injection parameters of the injection molding machine are the same as Comparative Example 3. A color plate test was conducted on the glass fiber reinforced polyamide material according to step (4) in Comparative Example 3.

The color plate prepared from the glass fiber reinforced polyamide material of Comparative Example 3 and Example 10 are cooled in the dry state for 12 hours, and then placed under the test conditions as shown in Tables 2 and 3 for color plate testing, and the test results obtained are shown in Tables 2 and 3. The temperature in the test conditions denotes a temperature of the mixture when it is subjected to melt blending in a twin-screw extruder, and the time denotes the retention time of the molten state.

TABLE 2
Test conditions and test results for color plates of Comparative Example 3

| | Color | | | | | | | | | |
|---|---|---|---|---|---|---|---|---|---|---|
| | Plate | Test | Light | | | | | | | |
| | Number | Condition | Source | L | a | b | ΔL | Δa | Δb | ΔE |
| Comparative | 1 | 260° C. - | D65 | 43.07 | 44.12 | 25.22 | / | / | / | / |
| Example | | stay for 2.5 | | | | | | | | |
| 3 | | minutes | | | | | | | | |
| | 2 | 260° C. - | D65 | 43.05 | 44.22 | 25.12 | −0.02 | 0.1 | −0.10 | 0.14 |
| | | stay for 2.5 | | | | | | | | |
| | | minutes | | | | | | | | |
| | 3 | 260° C. - | D65 | 43.47 | 43.14 | 23.52 | 0.40 | −0.98 | −1.70 | 2.00 |
| | | stay for 6 | | | | | | | | |
| | | minutes | | | | | | | | |
| | 4 | 260° C. - | D65 | 42.94 | 42.15 | 22.41 | −0.13 | −1.97 | −2.81 | 3.43 |
| | | stay for 10 | | | | | | | | |
| | | minutes | | | | | | | | |
| | 5 | 280° C. - | D65 | 43.97 | 44.00 | 24.5 | 0.90 | −0.12 | −0.72 | 1.16 |
| | | stay for 2.5 | | | | | | | | |
| | | minutes | | | | | | | | |
| | 6 | 280° C. - | D65 | 42.26 | 42.24 | 22.25 | −0.81 | −1.88 | −2.97 | 3.61 |
| | | stay for 6 | | | | | | | | |
| | | minutes | | | | | | | | |
| | 7 | 280° C. - | D65 | 41.68 | 40.01 | 20.07 | −1.39 | −4.11 | −5.15 | 6.73 |
| | | stay for 10 | | | | | | | | |
| | | minutes | | | | | | | | |

TABLE 3
Test conditions and test results of color plates of Example 10

| | Color | | | | | | | | | |
|---|---|---|---|---|---|---|---|---|---|---|
| | Plate | Test | Light | | | | | | | |
| | Number | Condition | Source | L | a | b | ΔL | Δa | Δb | ΔE |
| Example | 1 | 260° C. - | D65 | 44.04 | 43.61 | 25.08 | / | / | / | / |
| 10 | | stay for 2.5 | | | | | | | | |
| | | minutes | | | | | | | | |
| | 2 | 260° C. - | D65 | 44.14 | 43.54 | 24.97 | 0.10 | −0.07 | −0.11 | 0.16 |
| | | stay for 2.5 | | | | | | | | |
| | | minutes | | | | | | | | |
| | 3 | 260° C. - | D65 | 44.57 | 43.16 | 23.94 | 0.53 | −0.45 | −1.14 | 1.34 |
| | | stay for 6 | | | | | | | | |
| | | minutes | | | | | | | | |
| | 4 | 260° C. - | D65 | 43.47 | 42.23 | 23.15 | −0.57 | −1.38 | −1.93 | 2.44 |
| | | stay for 10 | | | | | | | | |
| | | minutes | | | | | | | | |
| | 5 | 280° C. - | D65 | 43.63 | 43.09 | 24.47 | −0.41 | −0.52 | −0.61 | 0.90 |
| | | stay for 2.5 | | | | | | | | |
| | | minutes | | | | | | | | |
| | 6 | 280° C. - | D65 | 42.82 | 42.51 | 23.28 | −1.22 | −1.10 | −1.80 | 2.44 |
| | | stay for 6 | | | | | | | | |
| | | minutes | | | | | | | | |
| | 7 | 280° C. - | D65 | 42.71 | 40.28 | 21.04 | −1.33 | −3.33 | −4.04 | 5.40 |
| | | stay for 10 | | | | | | | | |
| | | minutes | | | | | | | | |

The color plate 1 is taken as the reference sample, and the corresponding test results of the remaining color plates are compared with the color plate 1 to obtain the corresponding ΔL, Δa, and Δb. The smaller the color change chromatic aberration ΔE calculated from the above three parameters, the better the thermal stability and the better the heat resistance. At the same time, smaller values of ΔL, Δa, and Δb also indicate better thermal stability and better heat resistance.

According to the test results in Tables 2 and 3, it can be seen that under the same test condition, the b-value of the color plate of the glass fiber reinforced amide material with the addition of Tinuvin® 1600 increases, and ΔE becomes smaller, which indicates that Tinuvin® 1600 can improve the thermal stability and heat resistance of the glass fiber reinforced polyamide material to protect the color stability. In addition, the test data obtained at high temperature (280° C.) is superior to those obtained at normal processing temperature (260° C.), indicating that the addition of Tinuvin® 1600 further improves the thermal stability and heat resistance of the glass fiber reinforced amide material at a high processing temperature. The molecular structure of Tinuvin® 1600 is shown below:

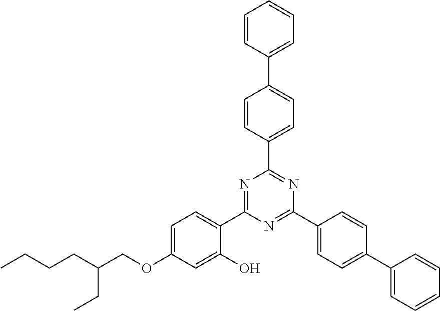 [SMILES: CCCCC(CC)COc1ccc(-c2nc(-c3ccc(-c4ccccc4)cc3)nc(-c3ccc(-c4ccccc4)cc3)n2)c(O)c1]

The phenolic hydroxyl group (—OH) can react with a free radical as a hydrogen donor, thus effectively capturing the free radical. Although the triazine ring itself does not react directly with the free radical, it can provide a stable ring-type for the phenolic hydroxyl group and thus indirectly support the antioxidant ability of the phenolic hydroxyl group. The synergistic effect of the two groups improves the thermal stability of the material.

The basic concepts have been described above, and it is apparent to a person skilled in the art that the foregoing detailed disclosure serves only as an example and does not constitute a limitation of the present disclosure. While not expressly stated herein, the person skilled in the art may make various modifications, improvements, and amendments to the present disclosure. These modifications, improvements, and amendments are suggested in the present disclosure, so these modifications, improvements, and amendments remain within the spirit and scope of the exemplary embodiments of the present disclosure.

Also, the present disclosure uses specific words to describe embodiments of the present disclosure. Such as “an embodiment” and/or “some embodiments” means a feature, structure, or characteristic associated with at least one embodiment of the present disclosure. Accordingly, it should be emphasized and noted that “one embodiment” or “an embodiment” or “an alternative embodiment” in different locations in the present disclosure do not necessarily refer to the same embodiment. In addition, certain features, structures, or characteristics of one or more embodiments of the present disclosure may be suitably combined.

Furthermore, unless expressly stated in the claims, the order of the processing elements and sequences, the use of numerical letters, or the use of other names as described in the present disclosure are not intended to qualify the order of the processes and methods of the present disclosure. While some embodiments of the invention that are currently considered useful are discussed in the foregoing disclosure by way of various examples, it is to be understood that such details serve only illustrative purposes and that additional claims are not limited to the disclosed embodiments; rather, the claims are intended to cover all amendments and equivalent combinations that are consistent with the substance and scope of the embodiments of the present disclosure.

Similarly, it should be noted that in order to simplify the presentation of the present disclosure, and thereby aid in the understanding of one or more embodiments of the invention, the foregoing descriptions of embodiments of the present disclosure sometimes combine a variety of features into a single embodiment, drawings, or descriptions thereof. However, this method of disclosure does not imply that more features are required for the objects of the present disclosure than are mentioned in the claims. Rather, claimed subject matter may lie in less than all features of a single foregoing disclosed embodiment.

Some embodiments use numbers to describe the number of components, attributes, and it should be understood that such numbers used in the description of embodiments are modified in some examples by the modifiers “approximately”, “nearly”, or “substantially”. Unless otherwise noted, the terms “about,” “approximate,” or “approximately” indicates that a ±20% variation in the stated number is allowed. Correspondingly, in some embodiments, the numerical parameters used in the present disclosure and claims are approximations, which are subject to change depending on the desired characteristics of some embodiments. In some embodiments, the numerical parameters should take into account the specified number of valid digits and employ general place-keeping. While the numerical domains and parameters used to confirm the breadth of their ranges in some embodiments of the present disclosure are approximations, in specific embodiments, such values are set to be as precise as possible within a feasible range.

For each of the patents, patent applications, patent application disclosures, and other materials cited in the present disclosure, such as articles, books, disclosure sheets, publications, documents, and the like, are hereby incorporated by reference in their entirety into the present disclosure. Application history documents that are inconsistent with or conflict with the contents of the present disclosure are excluded, as are documents (currently or hereafter appended to the present disclosure) that limit the broadest scope of the claims of the present disclosure. It should be noted that in the event of any inconsistency or conflict between the descriptions, definitions, and/or use of terms in the materials appended to the present disclosure and those set forth herein, the descriptions, definitions, and/or use of terms in the present disclosure shall prevail.

Finally, it should be understood that the embodiments described in the present disclosure are only used to illustrate the principles of the embodiments of the present disclosure. Other deviations may also fall within the scope of the present disclosure. As such, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

What is claimed is:

1. A glass fiber reinforced polyamide material, comprising components in the following parts by weight:
48-99.8 parts of a polyamide resin, 0-50 parts of a glass fiber, 0.05-2 parts of a thermal stability additive, and 0.1-2 parts of other additives; wherein
the thermal stability additive is hydroxyphenyltriazine compounds.

2. The glass fiber reinforced polyamide material of claim 1, wherein the thermal stability additive is 0.05-0.5 parts.

3. The glass fiber reinforced polyamide material of claim 1, wherein the hydroxyphenyltriazine compounds include at least one of 2,4-bis(2,4-dimethylphenyl)-6-(2-hydroxy-4-octyloxyphenyl)-s-triazine, 2-(4,6-diphenyl-1,3,5-triazin-2-yl)-5-hexyloxy, or 2-[4,6-di(4-biphenylyl)-1,3,5-triazine-2-yl]-5-(2-ethylhexyloxy) phenol.

4. The glass fiber reinforced polyamide material of claim 1, wherein the polyamide resin includes at least one of PA6, PA66, PA46, PA56, PA66/6, PA6T, PA9T, PA610, PA611, or PA612.

5. The glass fiber reinforced polyamide material of claim 1, wherein the other additives include at least one of a toner, a lubricant, or an antioxidant.

6. The glass fiber reinforced polyamide material of claim 5, wherein the toner includes at least one of zinc sulfide or an organic pigment.

7. The glass fiber reinforced polyamide material of claim 6, wherein the organic pigment includes at least one of an azo pigment, a heterocyclic pigment, a perylene pigment, or a metal complex pigment.

8. The glass fiber reinforced polyamide material of claim 5, wherein the lubricant includes at least one of stearate, N,N′-ethylenebis(stearamide), pentaerythritol stearate, silicone powder, or polyethylene wax.

9. The glass fiber reinforced polyamide material of claim 5, wherein the antioxidant includes at least one of an antioxidant S2225P, an antioxidant 168, an antioxidant 1010, or an antioxidant 1098.

10. The glass fiber reinforced polyamide material of claim 1, wherein a length-to-diameter ratio of the glass fiber is (20-40):1.

11. The glass fiber reinforced polyamide material of claim 1, wherein a color change chromatic aberration ΔE of the glass fiber reinforced polyamide material at a temperature of 250-280° C. is 0.15-0.92.

12. A method for preparing the glass fiber reinforced polyamide material of claim 1, comprising:
mixing 48-99.8 parts by weight of the polyamide resin, 0-50 parts by weight of the glass fiber, 0.05-2 parts by weight of the thermal stability additive, and 0.1-2 parts by weight of other additives uniformly by a mixer to obtain a mixture, wherein the thermal stability additive is hydroxyphenyltriazine compounds;
adding the mixture to a twin-screw extruder for melt blending and extruding strands, an extrusion temperature of the strands being 240-280° C.; and
pelletizing the strands by a pelletizer, drying by an elevator, and packaging to obtain the glass fiber reinforced polyamide material.

13. The method of claim 12, wherein the thermal stability additive is 0.05-0.5 parts.
